(19) United States
(12) Patent Application Publication
(10) Pub. No.: US 2012/0267332 A1
(43) Pub. Date: Oct. 25, 2012

(54) Modular Pallet Rack System

(76) Inventor: Fabio Mariani, North York (CA)

(21) Appl. No.: 13/090,622

(22) Filed: Apr. 20, 2011

(51) Int. Cl. A47B 47/00; B23P 11/00; A47B 95/00

(52) U.S. Cl. 211/206; 211/183; 29/428

(57) ABSTRACT

An upright for a modular rack system to support a horizontal beam extending normal to the said upright, the upright comprising a plurality of female connectors to receive corresponding male connectors of the horizontal beam, the upright has a generally rectangular profile adapted to receive the horizontal beam extending in any one of four perpendicular directions, said upright with said beam are used to erect a rack system.

### FIELD OF THE INVENTION

Modular pallet racks, specifically racks having vertical posts interconnected by horizontal beams capable of being assembled and disassembled using the connecting members on the posts and beams.

### BACKGROUND OF THE INVENTION

This invention relates generally to racks and more particularly, to pallet racks. Racks are well known in the industry for storage of items in storage facilities. Various modular racks are used in the industry having the benefits of being assembled and disassembled accordingly to the requirement of a storage. Most of the pallet racks have several common elements: First common element is an upright or a vertical post which supports the horizontal beams, second element is horizontal beams extending between the uprights to support pallets or shelves. There is also a third element—cross segments connecting the uprights extending in the plain generally perpendicular to the plane of horizontal beams, those cross segments add rigidity to the structure of the rack. Fourth element comprises a plurality of connectors such as bolts, nuts and various brackets to connect the beams and cross segments to the uprights see, for example, U.S. Pat. No. 3,625,372.

The plurality of segments makes the process of the assembly, disassembly and transportation of the pallet racks a complicated task. The assembly and disassembly process required a use of several tools and constant supply of small assembly pieces. The small loose pieces such as bolts and nuts can easily get lost, stuck in between the parts of the racks and hamper the assembly process. Therefore, there is a need to reduce or eliminate the use of the small assembly parts in a rack erection process.

Another deficiency of the pallet racks currently used in the industry, is the linear way of construction. All the pallet racks used in the industry are built in straight lines. This arrangement works well in large warehouse spaces with generally rectangular floor plans. However, in smaller warehouses with irregular floor plans the linear way of rack construction results in a loss of space. Further some floor plans and storage articles would require “+” shaped “T” shaped or “L” shaped arrangement of pallet racks or a combination of those arrangements to address supporting columns, corners and other wall and floor plans irregularities. Therefore, there is a need for a pallet rack designed to be built in different shapes besides the straight lines' structures.

Further the object of the invention is to provide a pallet racks system comprising of only two essential elements: vertical support posts and horizontal beams. This rack system can be erected in various geometrical layouts according to the floor plan.

### SUMMARY OF THE INVENTION

According to one aspect of the invention, there is provided a rack system. The rack system has vertical supporting posts or uprights and horizontal beams. The horizontal beams are interconnected with the posts to erect the rack system. The horizontal beams can be connected to two posts while extending in any one of four perpendicular directions. The post is further designed to be attached to beams simultaneously extending in two, three or four horizontal perpendicular directions from the same post.

According to another aspect of the invention, there is provided an upright for a modular rack system to support a horizontal beam extending normal to the said upright. The upright has a plurality of female connectors to receive corresponding male connectors of the horizontal beam. The upright also has a generally rectangular profile adapted to receive the horizontal beam extending in any one of four perpendicular directions. The combination of upright with said beam is used to erect a rack system.

According to yet another aspect of the invention, there is provided a beam for a modular rack system. The beam has an L-shaped grip member on the first end and a mirrored L-shaped grip member on the second end. The grip members have a plurality of male connectors to engage corresponding female connectors of two previously discussed uprights at each end. The beam with the upright are used to erect a modular rack system.

According still another aspect of the invention, there is provided a modular rack system having upright members and horizontal beam members, while each upright member has a generally rectangular profile and a plurality of female connectors, and each horizontal beam has an L-shaped grip member on each side. Each L-shaped grip member, while attached, wraps around the corner of the upright. Further each grip member has a set of male connectors interconnecting with corresponding female connectors of the upright member. The horizontal beams can extend from the upright in four perpendicular directions, for example, the horizontal beam might extend right and left from the upright to engage additional uprights and also might extend forward and backward from the same upright to engage additional uprights, this way the rack system can be flexibly arranged to fit a range of floor plans.

Preferably, the L-shaped grip of has a set of male connectors selected from the group of: hooks, double hooks, tabs, loops, pins and other connectors known in the art. Still preferably the L-shaped grip of the beam has a leg, a foot and a finger part. It further has a first set of the male connectors on the foot part of the L-shaped grip and a second set of male connectors on the finger part of the L-shaped grip. The first and the second set of connectors are independently selected from the group of hooks, double hooks, tabs, loops, pins and other connectors known in the art.

According to yet another aspect of the invention there is provided an upright having a generally rectangular X-shaped profile with four vertical walls, while each vertical wall has a vertical channel proximate the center of the wall. Each wall further has a first set of female connectors to receive the first set of male connectors of the grip members of the beam while each channel comprises a second set of female connectors to receive the second set of male connectors of the grip members of the beam. This way, the interconnecting upright and the beam are used to erect a modular rack system.

According to yet another aspect of the invention there is provided a method of erecting a rack system by use of generally rectangular X-shaped uprights and horizontal beams comprising L-shaped grip members while each grip member wraps a corner of the upright. Each upright has a plurality of connecting female connectors and each grip member comprising a set of male connectors engageable with those female connectors. Each horizontal beam connects two uprights and may extend in a normal direction from the upright—right, left, forward or backward.

Preferably, the L-shaped grip further comprising a first set of male connectors on the foot part of the L and a second set of male connectors on the finger part of the L. The first and second set is independently selected from the group of hooks, double hooks, tabs, loops, pins and other connectors known in the art.

Still preferably the upright having a generally rectangular X-shaped profile with four vertical walls, further comprises vertical channels proximate the center of each wall. In addition each wall comprises a first set of female connectors to receive the first set of male projections of the beam while each channel comprises a second set of female connectors to receive the second set of male connectors of the beam. The interconnecting uprights and the beams are used to erect a modular rack system.

According to yet another aspect of the invention the rack system described above can have an upright with a plurality of male/female connectors and each L-shaped grip of the horizontal beam, can comprise a plurality of corresponding male/female connectors to engage said upright.

Further benefits of the invention would be apparent through a review of the description, drawings and the claims of the invention.

### BRIEF DESCRIPTION OF THE DRAWINGS

FIG. 1 is a schematic view of an assembled rack system.

FIG. 2 is a front view of a fragment of the upright illustrating a preferred embodiment.

FIG. 3 is a perspective view of the fragment of the upright illustrating a preferred embodiment.

FIG. 4 is a top view of the upright.

FIG. 5 is a perspective view of a beam with L-shaped grip illustrating a preferred embodiment.

FIG. 6 is a perspective view of a beam with mirror L-shaped grip illustrating a preferred embodiment.

FIG. 7 is a front view of L-shaped grip illustrating a preferred embodiment.

FIG. 8 is a front view of the upright with one horizontal beam attached.

FIG. 9 is a front view of the upright with two parallel horizontal beams attached.

FIG. 10 is a top view of the upright with two horizontal beams attached perpendicularly to each other.

FIG. 11 is a side view of the upright with two horizontal beams attached perpendicularly to each other.

FIG. 12 is a top view of the upright with three horizontal beams attached.

FIG. 13 is a top view of the attachment of two parallel beams.

FIG. 14 is a top view of the attachment of two perpendicular beams.

FIG. 15 is a top view of the upright with four horizontal beams arranged counter-clockwise.

FIG. 16 is a top view of the upright with four horizontal beams arranged clockwise.

### DETAILED DESCRIPTION OF PREFERRED EMBODIMENTS

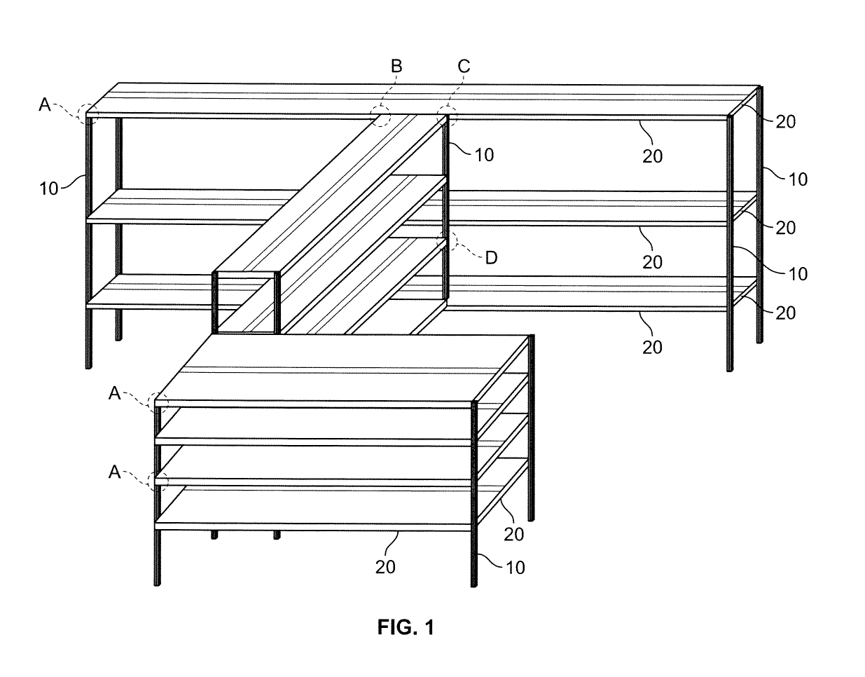

FIG. 1 shows a rack system erected in the storage facility. It is easy to see that the system has an irregular shape. It actually is having a “T” shaped segment extending into “L” shaped segment. Further it illustrates that the positions and width of shelves can vary from one segment of shelves to another. The arrangement of the FIG. 1 is just one of the examples demonstrating the flexibility of the modular rack system. The main segments of the system are: uprights 10 and horizontal beams 20. The horizontal beams can be manufactured to any length and thickness suitable for the support of the pallets, shelves and other supporting parts known in the art.

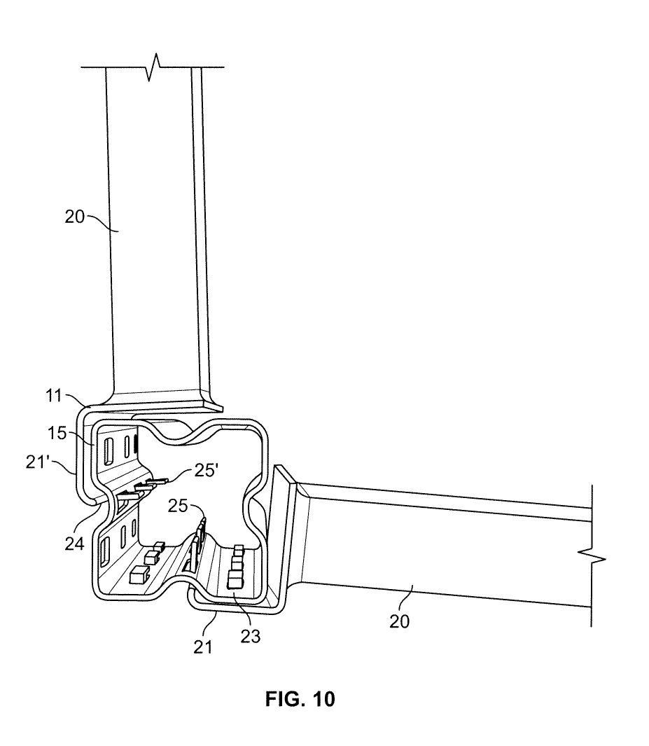

There are several examples of attachment of horizontal beams 20 to uprights 10. Attachment “A” has two horizontal beams extending from upright 10 the beams are perpendicular to each other while one is extending to the right and other extending to the back from the upright. The point of attachment “A” is best illustrated in FIG. 10. The similar point of the attachment with two horizontal beams perpendicular to each other can be found in other points in the FIG. 1.

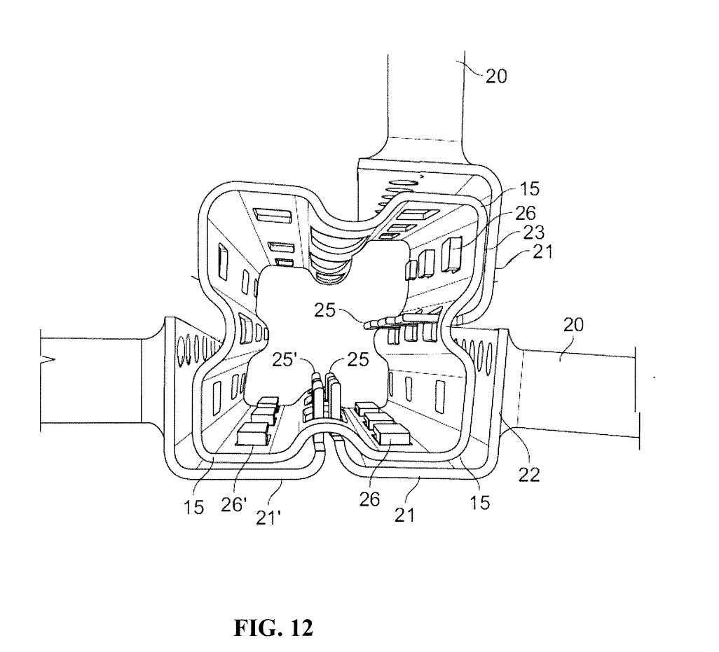

Attachments “B” and “C” shows three horizontal beams extending from the same point of the upright. At those points one beams is extending to the left, second to the right and the third one to the front from the upright. The points of attachment “B” and “C” are best illustrated in FIG. 12.

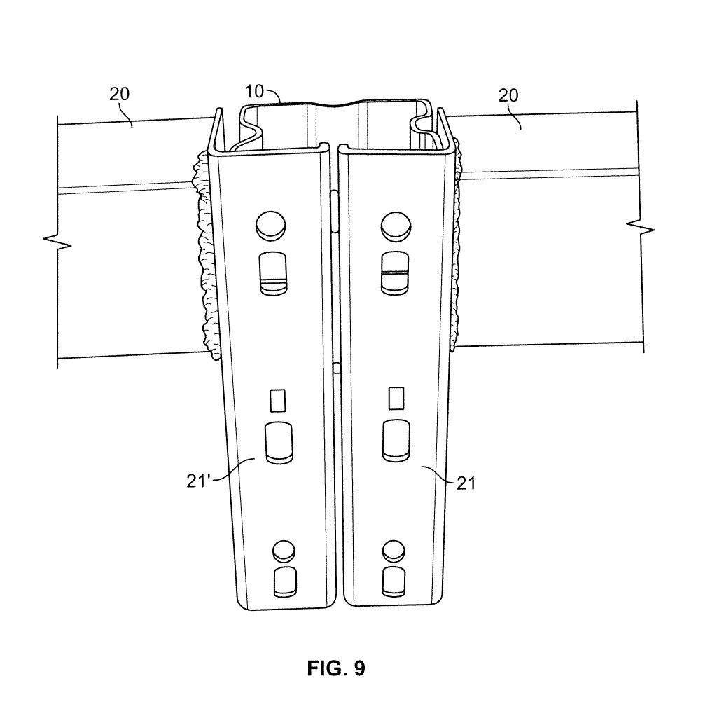

The point of attachment “D” illustrate two horizontal beams extending from the upright, one to the left and one to the right. This point of attachment is best illustrated in FIG. 9.

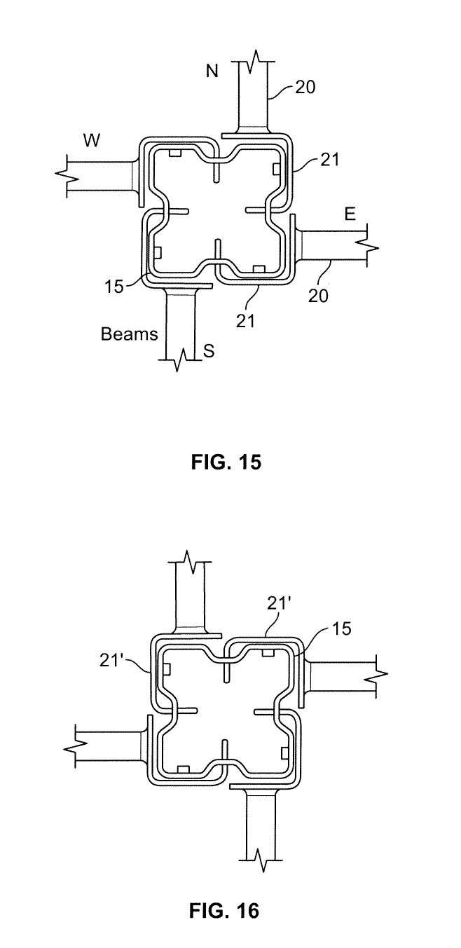

There are also existing points of attachment in which beams are extending to all four perpendicular directions from the same point of the upright as shown in FIGS. 15 and 16. In this case, the horizontal beams can be attached to the upright in a clockwise way see the FIG. 16 or counter clockwise way see FIG. 15.

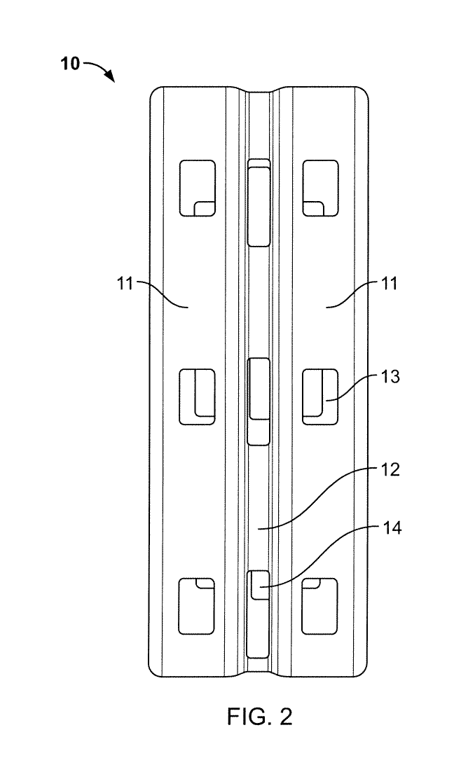

FIG. 2 shows a segment of the upright 10 having vertical walls 11. The height of the upright can vary accordingly to the requirement of the customer. The upright has a plurality of female connection means to receive a corresponding plurality of male connection means of the horizontal beams. It is understood that there are many possible ways to connect a beam to a post using male/female connection means.

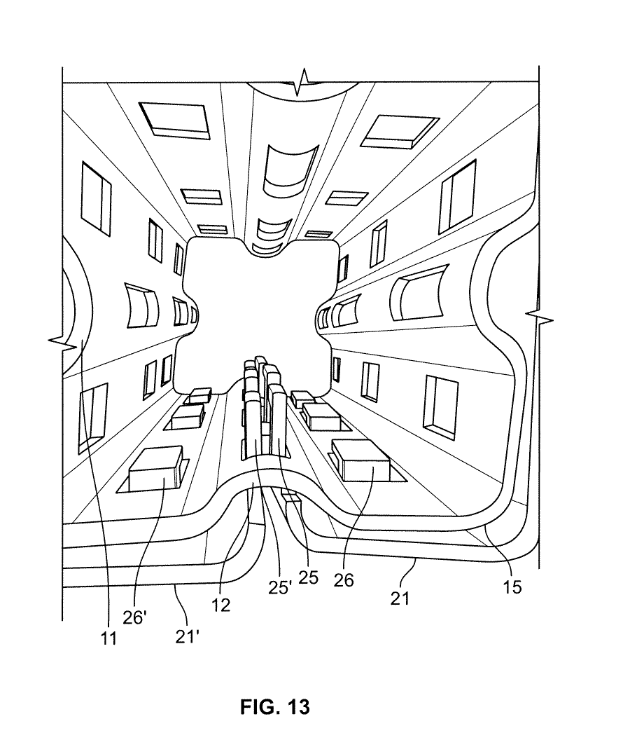

One feature of the post in this invention is the fact that there are two ways to attach two beams extending 180 degrees from each. First using the same plane see FIG. 9 and FIG. 13. And second using opposite planes of the upright see FIG. 15 beams N, S or E, W.

Further there are two ways to attach two beams perpendicular to each other. First while the beams grips are wrapping neighbouring corners see FIG. 15 beams N & E, W & S, S & E or N & W. And second while beam grips wrapping opposing corners of the post see FIG. 10.

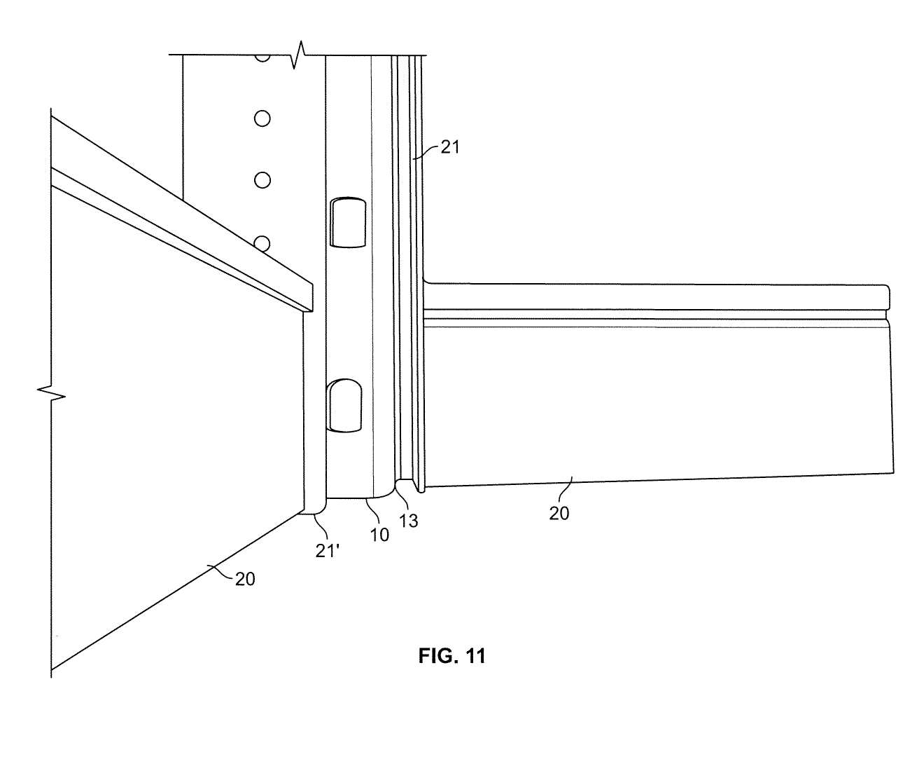

The post or the upright of the FIG. 11 has a plurality of female openings of the first type 13 and plurality of the female openings of the second type 14. Openings 13 are designed to receive male connectors 26 of the beam, and the openings 14 designed to receive male connectors 25 of the beam. Although it is preferred that two types of connecting pairs are utilized in the system, the system can be built with a single set of connectors or several sets of connectors of same or different types.

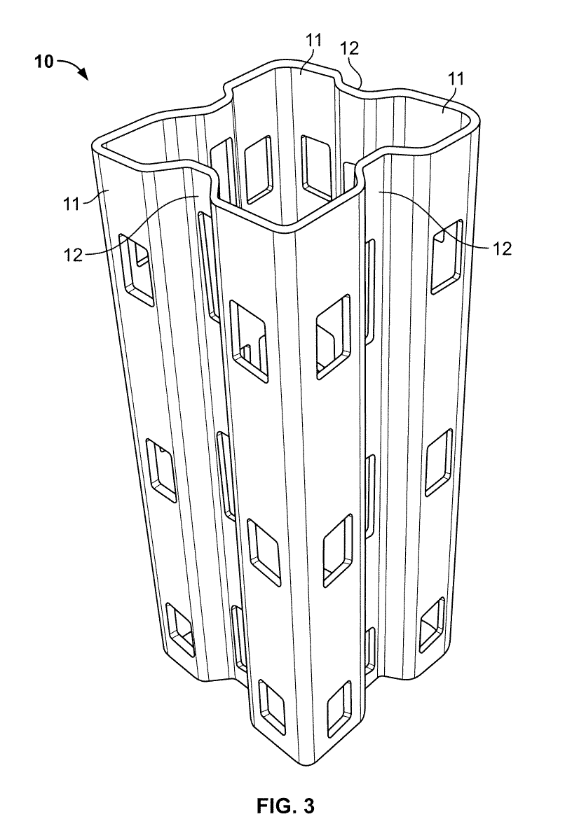

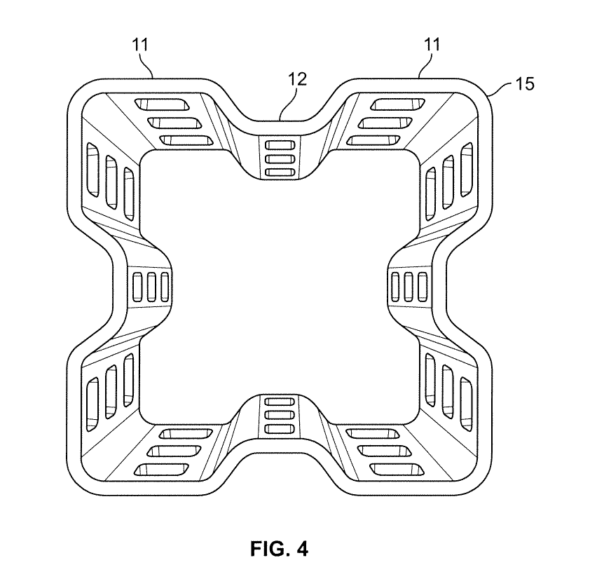

FIGS. 3 and 4 show another view of the preferred embodiment of the current invention. Those Figures illustrate the channels 12 which extends along the walls 11 of the post 10. The channels are indented into the plane of the post wall proximate the centre of the wall and comprise the second set of openings 14. As best seen in FIG. 4, post 10 has a generally “X” shaped structure, when viewed from the top. In some variants of the invention, the post can have more than one channel per wall. For example, there might be a post with two channels per wall while each of them having female openings to receive male connectors from the beams. In another embodiment the poll walls can have no channels at all, but only female connectors receiving mail connectors of the beams.

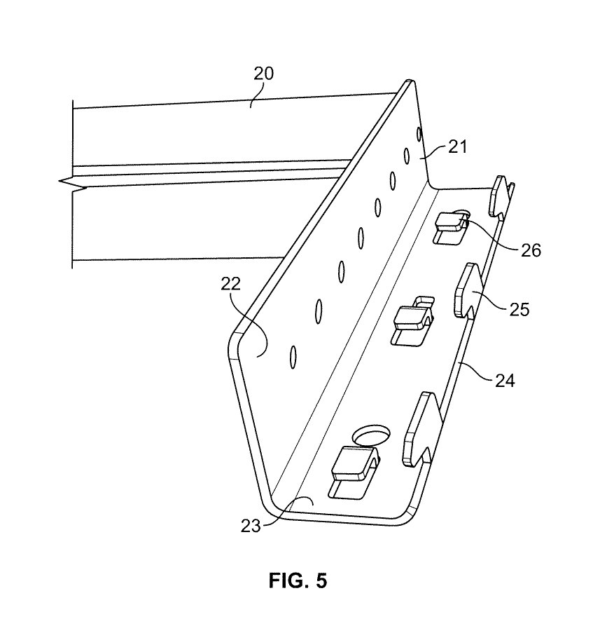

FIG. 5 shows beam 20 with a first grip member 21. The grip member 21 engages with the post 10 by the means of male connectors or hooks 25 and 26. It should be noted that there is a large variety of male female interconnecting members who can be utilized in order to interconnect horizontal beam 20 with upright 10.

Preferably, the grip member 21 is an “L” shaped grip having a leg 22, a foot 23 and a finger part 24 with hooks 25 extending from the finger part of the grip. This “L” shaped structure allows the grip member 21 to wrap around the corner 15 of the upright 10 as best illustrated in FIG. 10. The width of the members 22 and 23 can be the same or different, depending on the design of the beam. Preferably, the dimensions of members 22 and 23 should be smaller than one half of the width of the upright in order to permit attachment of two grip members on one side of the upright as illustrated in FIG. 9.

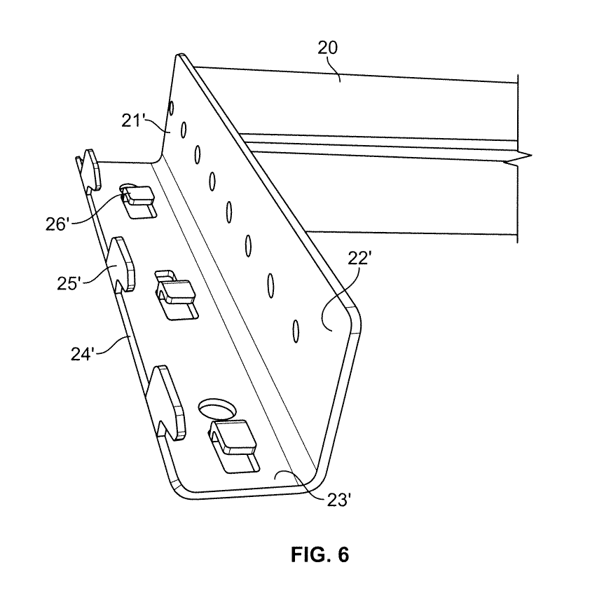

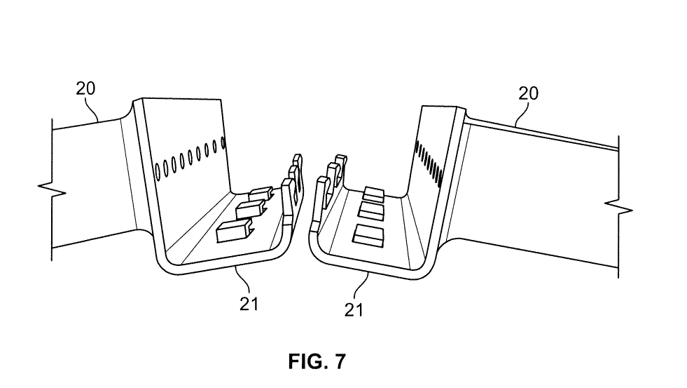

FIG. 6 shows the second “mirrored” grip 21′ of the beam 20. It also has an “L” shape structure with a leg 22′, a foot 23′, a finger 24′ and male connecting members 26′ on the foot part and 25′ on the finger part, to engage female members 13 and 14 of upright 10. FIG. 7 illustrates the mirror view of the “L” shaped members 21 and 21′.

The number of connecting male/female members on the grip portion of the beam may vary. As discussed above, they can be of same type or different types, there might be one member only, or series of those members. Alternatively, and preferably there can be a set of different connecting members or series of those sets. In FIGS. 5 and 6 there are three sets of members 26′ and 25′, however there might be one set, two sets or more sets. Preferably, two or three.

The “L” shaped structure of the grip 21 including the finger part 24 adds to the rigidity of the structure by increasing the surface contact between the grip member and the upright. This contact, adds an effect of friction to the grip effect of the interconnecting male/female members. This way the erected structure gets improved rigidity and stability.

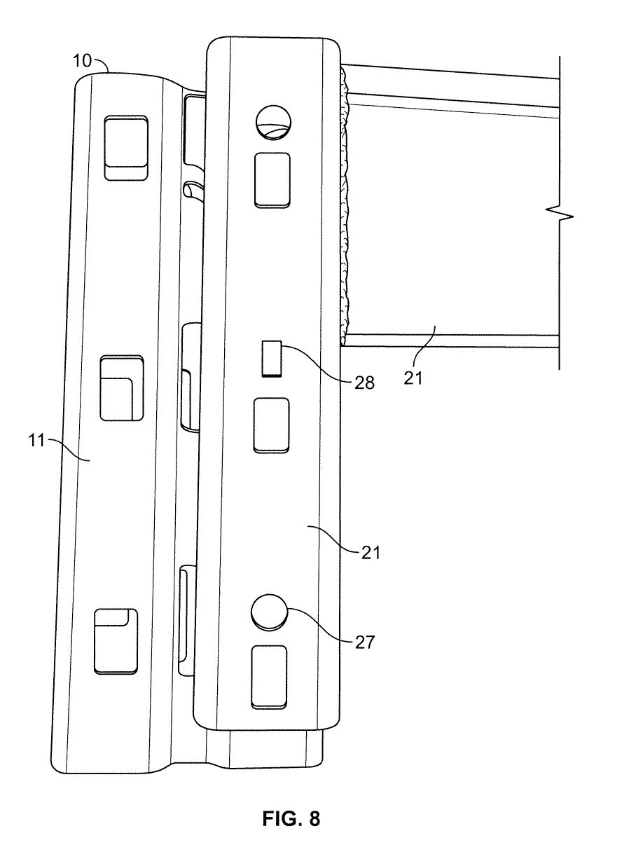

FIG. 8 illustrates an interconnecting relationship between the grip member 21 and the upright 10. It is important to notice that there is still space left to attach another beam with a grip member 21′ to the left of the connected beam.

Another important aspect is the fact that while the beam is extending to the right of the post, the grip is attached to the front of the post while a grip member effectively. This way of wrapping the corner of the post provides better distribution of the force applied on the beam, by using the whole grip member and not only the male/female interconnecting members.

The grip members can further include additional fastening means known in the art, for example, openings 28 and 27 provided to use of beam locks (not shown).

FIG. 9 shows a way in which two opposite beams can be attached to the same upright. The beams are extending to the right and to the left of the post while the male/female engagement takes place in the front of the post.

FIGS. 10 and 11 illustrate the perpendicular connection of two beams to a post while. This is a view from the top. Therefore, one beam with grip 21 extends to the right and beam with grip 21′ extends to the back from the post.

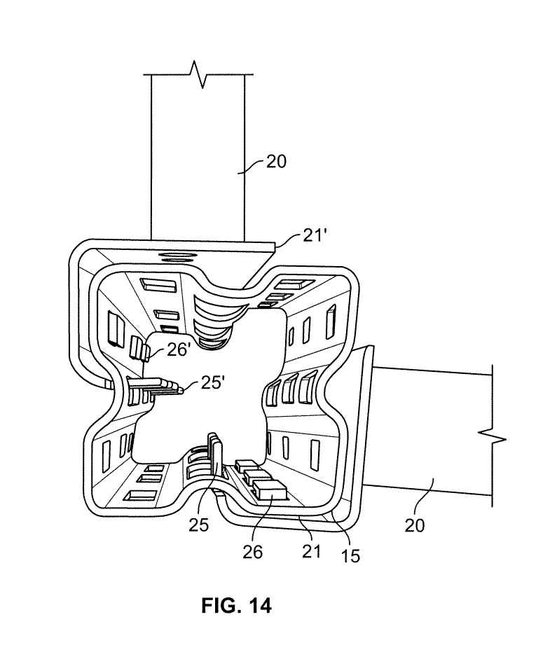

FIG. 12 illustrates one of the ways to connect three horizontal beams to an upright: two beams with grip 21 and one with grip 21′. In this figure, there is one of the embodiments of overlapping grip structure, while the leg 22 of one of the grips overlaps the foot 23 of another grip 21. In the preferred embodiment, the leg 22 of the grip 21 is shorter and therefore the overlapping does not take place. This Figure also illustrates the interconnection of the connecting male/female members 25, 26, 25′, 26′ with the corresponding receiving members 13, 14. It is important to notice that while each member 13 receives one member 26 or 26′, the receiving member 14 can receive both member 25 and 25′. FIG. 13 illustrates the members 25 and 25′ received by the member 14 in the channel 12. FIG. 14 illustrates how one receiving member 14 receives member 25 on the bottom and another receiving member 14, receives member 25′ on the left. Furthermore, this figure illustrates the “L” shaped grip members wrapping around corners 15′.

FIGS. 15 and 16 show arrangement of four horizontal beams in counter-clockwise arrangements with grip members 21 and clockwise arrangements with grip members 21′. In this illustration, the sizes of walls 22 and 22′ are corresponding to the preferred embodiment and are smaller then the half width of the beam 10.

The beams and posts of the rack system are made of metal or other suitable material known in the art to support the load imposed on the rack systems. The manufacturing of the male/female connector members can take place during the manufacturing of the beams, grips and posts or following the production by means known in the art.

In the preferred embodiment, the female connecting members are positioned on the uprights while the male connecting members are located on the grip members of the beams. However alternate arrangements can work as well. For example, upright 10 might have the male connectors 26 instead of female connectors 13 while the grip member 21 can have female connectors 13 instead of male connectors 26. It is still preferable that the male connectors 25 will be located on the grip member 21 to engage the female connecting member 14 on the post 10.

The grip member of the beam can have any number of male/female connecting members to assure sufficient grip between the beam and the post and to provide a sufficient load distribution between the connecting members. Preferably there are at least two types of male connecting members flat hooks 26 and tapered hooks 25. Still preferably there are more than one connecting member of each type. Preferably, two to four of each type. The positioning of the female connectors on the upright had to be adapted to the position of the male connecting members on the grip members. This way the grip member can be attached at any desirable height along the upright to address the requirements of the storage facility.

It is preferable that the post will have the channels 12, to increase the rigidity of the post, to receive the finger part 24 of the grip 21 and preferably to accommodate the female slots 14 to receive the hooks 25.

The design of the posts and beams allows the erection of the rack system accordingly to the requirements and limitation of the storage facility addressing the floor plan, wall arrangement and height restriction. The connecting members allow easy connecting of the parts of the rack system provide sufficient grip during the use of the rack system, but also allow simple disconnection for rearrangement and relocation of the rack system.

The lengths of the horizontal beams can be of standard sizes to erect a modular rack system, and also can be custom sized to fit special cases of storage facilities. In any case, the uprights will be able to support all the beams.

Many variations and modifications can be made to the system described above without departing from the scope of the invention. All the illustrations provided as an example and in non limiting way.

We claim:

1. An upright for a modular rack system to support a horizontal beam extending normal to the said upright, the upright comprising a plurality of female connectors to receive corresponding male connectors of the horizontal beam, the upright has a generally rectangular profile adapted to receive the horizontal beam extending in any one of four perpendicular directions, said upright with said beam are used to erect a rack system.

2. A beam for a modular rack system, said beam comprising an L-shaped grip member on the first end and a mirrored L-shaped grip member on the second end, the grip members comprising a plurality of male connectors to engage corresponding female connectors of two uprights of the claim 1 on each end, said beam with said upright are used to erect a modular rack system.

3. A modular rack system comprising upright members and horizontal beam members, each upright member has a generally rectangular profile and a plurality of female connectors, each horizontal beam has an L-shaped grip member on each side, each L-shaped grip member, while attached, wraps around the corner of the upright; each grip member has a set of male connectors interconnecting with corresponding female connectors of the upright member, wherein the horizontal beams can extend from the upright in four perpendicular directions, this way the horizontal beam might extend right and left from the upright to engage additional uprights and also might extend forward and backward from the same upright to engage additional uprights, this way the rack system can be flexibly arranged to fit a range of floor plans.

4. The L-shaped grip of claim 3 comprising a set of male connectors selected from the group of: hooks, double hooks, tabs, loops, pins and other connectors known in the art.

5. The L-shaped grip of claim 3 having leg, foot and finger parts, comprising a first set of the male connectors on the foot part of the L-shaped grip and a second set of male connectors on the finger part of the L-shaped grip, wherein the first and the second set are independently selected from the group of hooks, double hooks, tabs, loops, pins and other connectors known in the art.

6. An upright having a generally rectangular X-shaped profile with four vertical walls, while each vertical wall comprises a vertical channel proximate the center of the wall, each wall comprises a first set of female connectors to receive the first set of male connectors of claim 5 while each channel comprises a second set of female connectors to receive the second set of male connectors of claim 5; the interconnecting upright and the beam are used to erect a modular rack system.

7. A method of erecting a rack system comprising use of generally rectangular X-shaped uprights and horizontal beams comprising L-shaped grip members, wherein each grip member wraps a corner of the upright, each upright comprising a plurality of connecting female connectors and each grip member comprising a set of male connectors engageable with those female connectors, each horizontal beam connects two uprights and may extend in a normal direction from the upright—right, left, forward or backward.

8. The method of claim 7 wherein the L-shaped grip further comprising a first set of male connectors on the foot part of the L and a second set of male connectors on the finger part of the L, wherein the first and second set are independently selected from the group of hooks, double hooks, tabs, loops, pins and other connectors known in the art.

9. The method of claim 8, wherein the upright having a generally rectangular X-shaped profile with four vertical walls, further comprises vertical channels proximate the center of each wall; each wall comprises a first set of female connectors to receive the first set of male projections while each channel comprises a second set of female connectors to receive the second set of male connectors; the interconnecting uprights and the beams are used to erect a modular rack system.

10. The rack system of claim 3 wherein the upright comprises a plurality of male/female connectors and each L-shaped grip of the horizontal beam, comprises a plurality of corresponding male/female connectors to engage said upright.

11. The method of claim 9 wherein the upright comprises a plurality of male/female connectors and each L-shaped grip of the horizontal beam, comprises a plurality of corresponding male/female connectors to engage said upright.
